(19) United States
(12) Patent Application Publication
(10) Pub. No.: US 2010/0147875 A1
(43) Pub. Date: Jun. 17, 2010

(54) Device for introducing additive fluids into a primary fluid

(75) Inventors: Gregorio D. Santos, Chicago, IL (US); Gregory M. Billman, Hoffman Estates, IL (US)

Correspondence Address: PYLE & PIONTEK LLC, 221 N. LASALLE STREET, SUITE 1207, CHICAGO, IL, 60601, US

(73) Assignee: IMI Cornelius Inc.

(21) Appl. No.: 12/658,668

(22) Filed: Feb. 12, 2010

Related U.S. Application Data
(63) Continuation of application No. 11/487,845, filed on Jul. 17, 2006.
(60) Provisional application No. 60/700,205, filed on Jul. 18, 2005.

(51) Int. Cl. B67D 7/00; B05B 11/02; B67D 7/74

(52) U.S. Cl. 222/1; 222/631; 222/129.1

(57) ABSTRACT

A device for introducing additive fluids to a primary fluid is characterized by a body having a central bore for flow therethrough of a stream of primary fluid, and a plurality of fluid flow channels in the body. Each channel extends between an inlet to the channel for connection to an associated supply of additive fluid and a plurality of outlet orifices from the channel that open into a surface of the body around and outside of an exit from the central bore. Additive fluid is emitted from the outlet orifices in a direction ranging from the additive fluid being directed generally parallel to a stream of primary fluid exiting the central bore to the additive fluid being directed toward and against the stream of primary fluid.

This application is a continuation of application Ser. No. 11/487,845, filed Jul. 17, 2006 and now abandoned, which claimed benefit of provisional application Serial No. 60/700,205, filed Jul. 18, 2005.

### FIELD OF THE INVENTION

The present invention relates generally to beverage dispensing equipment, and in particular to specialized nozzles used in beverage dispensing equipment to provide additive flavors, coloring and the like to dispensed beverages.

### BACKGROUND OF THE INVENTION

Fountain beverage dispensing equipment is well known in the art and includes various types of machines for dispensing liquid drinks and for making and dispensing slush ice drinks as well. Typically, drinks are dispensed from one or more dedicated valves, each structured to dispense a single flavor. In order to save space and cost, it is known to have multiple flavor valves that have the capacity to dispense a plurality of flavors from the same nozzle, but such valves dispense only one flavor at a time.

Various carbonated drinks, particularly cola drinks, have long been available, especially in bottled form, with various flavorings such as cherry, vanilla and lemon added to the basic syrup formulation of the drinks. While additive flavors can be included in the syrup formulations as supplied to the drink retailer, such an approach increases the number of dedicated valves that are required to dispense the different flavored beverages. Thus, for example, in addition to a basic cola flavor and its diet counterpart, there would need to be separate valves for cherry and vanilla versions of each, and so on. This number can be increased further if caffeinated and non-caffeinated versions of the beverages are desired. The problem becomes particularly acute for slush ice or so-called frozen carbonated beverage “FCB” dispensing equipment, which typically can only serve two or four flavors per machine and where the cost per flavor is considerably higher than with liquid beverage dispensing equipment.

Accordingly, it would be desirable to have a mechanism for optionally adding one or more flavors to a base drink in such manner that the number of valves, and hence the complexity and cost of the beverage dispensing equipment, can be reduced. One such mechanism is disclosed in patent application Ser. No. 10/938,329, filed Sep. 10, 2004, the teachings of which are specifically incorporated herein by reference.

### SUMMARY OF THE INVENTION

In accordance with the present invention, there is provided a device for introducing additive fluids to a primary fluid. The device comprises a body having a central bore for flow therethrough of a stream of primary fluid and a plurality of fluid flow channels, each extending between an inlet to the channel for connection to an associated supply of additive fluid and a plurality of outlet orifices from the channel that open into a surface of the body around and outside of an exit from the central bore for emission of additive fluid in a selected direction ranging from the additive fluid being directed generally parallel to a stream of primary fluid exiting the central bore to the additive fluid being directed toward and against the stream of primary fluid.

In a preferred embodiment of the device, the plurality of outlet orifices from each fluid flow channel open into the body surface in equally angularly spaced relationship and lie in a common plane. To facilitate manufacture of the device, the body comprises a series of layers, each having a central bore formed therethrough and a fluid flow channel formed in at least one surface thereof, the layers being registered one above the other and sandwiched together to form the body having the central bore and the plurality of separate fluid flow channels extending through the body between the inlets to and the outlet orifices from the channels. Means are provided for initiating delivery of a selected additive fluid to the inlet to a channel for flow through the channel to and from the outlet orifices from the channel for addition to a primary fluid flowing through the central bore, and advantageously included are means for controlling delivery of a selected additive fluid to occur only in response to a flow of a primary fluid through the central bore.

The invention advantageously is embodied in a beverage dispenser comprising a valve for dispensing a stream of a beverage and a device for introducing additive fluid flavorings to the beverage. The device includes a body having a central bore for flow therethrough of a stream of beverage dispensed by the valve and a plurality of fluid flow channels, each extending between an inlet to the channel for connection to an associated supply of additive fluid flavoring and a plurality of outlet orifices from the channel that open into a surface of the body outside of and around an exit from the central bore, for emission of additive fluid flavoring in a selected direction ranging from the additive fluid flavoring being directed generally parallel to the stream of beverage exiting the central bore to the additive fluid flavoring being directed toward and against the stream of beverage.

The invention also contemplates a method of introducing additive fluids to a primary fluid, which comprising the steps of providing a body having a central bore and a plurality of fluid flow channels each extending between an inlet to the channel and a plurality of outlet orifices from the channel that open into a surface of the body outside of and around an exit from the central bore; fluid coupling the inlet to each channel to an associated supply of additive fluid; flowing a stream of primary fluid into, through and out of the exit from the central bore; flowing additive fluid from at least one supply thereof to the inlet to a channel and through the channel to the outlet orifices from the channel; and emitting the additive fluid from the outlet orifices in a selected direction ranging from the additive fluid being directed generally parallel to the stream of primary fluid exiting the central bore to the additive fluid being directed toward and against the stream of primary fluid.

In a practice of the method, the plurality of outlet orifices from each fluid flow channel open into the surface in a common plane and in angularly spaced relationship around the exit from the central bore. Also, the step of providing a body comprises the steps of providing a series of layers, each having a central bore and a fluid flow channel in at least one surface thereof, registering the layers one above the other, sandwiching the layers together to form the body having the central bore and the plurality of separate fluid flow channels extending through the body between the inlets to and the outlet orifices from the channels, and fastening the layers together. Facing surfaces of at least two adjacent layers have fluid flow channels which are complementary to each other and register one with the other to form a fluid flow channel through the body.

A preferred practice of the method resides in introducing additive fluid flavorings to a beverage dispensed from a beverage dispensing valve of a beverage dispenser. In this case, the method comprises the steps of providing a body having a central bore and a plurality of fluid flow channels extending through the body, each channel extending between an inlet to the channel and a plurality of outlet orifices from the channel that open into a surface of the body outside of and around an exit from the central bore; fluid coupling the inlet to each channel to an associated supply of additive fluid flavoring; operating the beverage dispensing valve to flow a stream of beverage into, through and out of the exit from the central bore; delivering additive fluid flavoring to the inlet to a channel for flow through the channel to the outlet orifices from the channel; and emitting the additive fluid flavoring from the channel outlet orifices in a selected direction ranging from the additive fluid flavoring being directed generally parallel to the stream of beverage exiting the central bore to the additive fluid flavoring being directed toward and against the stream of beverage.

The foregoing and other objects, advantages and features of the invention will become apparent upon a consideration of the following detailed description, when taken in conjunction with the accompanying drawings.

### BRIEF DESCRIPTION OF THE DRAWINGS

FIG. 1 shows a pictorial view of the multi-flavor injection device of the present invention, as secured to a dispensing valve of a slush ice dispensing machine;

FIG. 2 is a perspective and partly cross-sectional view of the multi-flavor injection device;

FIG. 3 is a perspective bottom view of the multi-flavor injection device;

FIG. 4A is a perspective exploded assembly view of a standard slush ice machine dispensing valve, together the multi-flavor injection device, and

FIG. 4B is a perspective view of the standard slush ice machine dispensing valve having, the injection device secured thereto.

### DETAILED DESCRIPTION

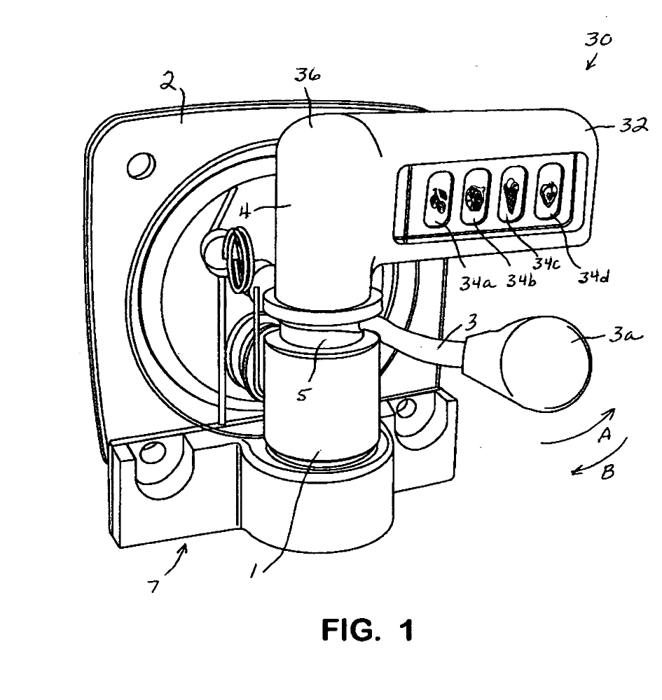

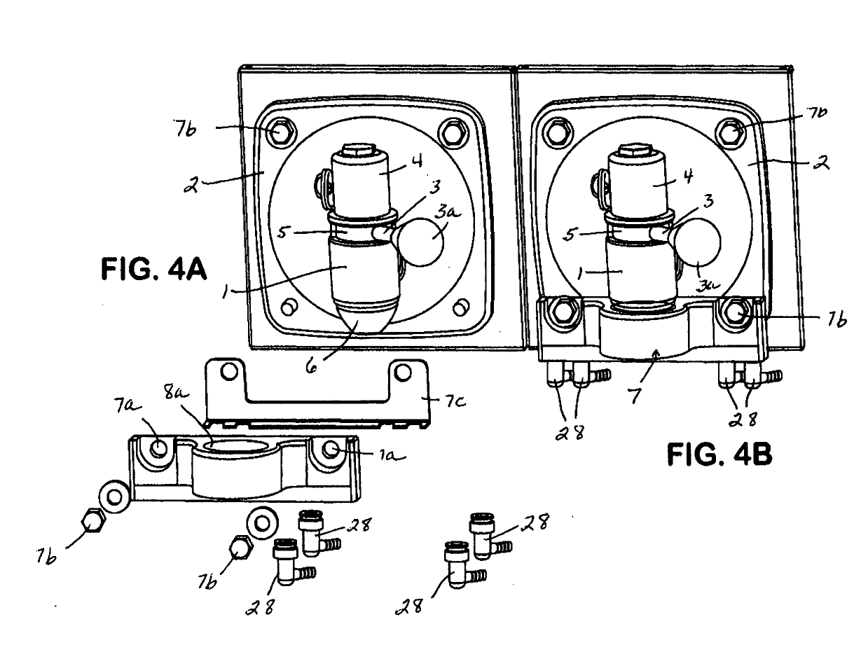

The multi-flavor injection device of the invention, for adding flavors to a base beverage, will be described for use in connection with a slush ice beverage dispensing machine, although it is to be appreciated that the invention also finds utility with other types of beverage dispensers. Referring to FIGS. 1, 4A and 4B, a slush ice dispensing valve 1 is secured to a face plate 2 on a front surface of a slush ice beverage dispensing machine. The face plate 2, as is well known, covers and endoses an open end of a refrigerated freeze cylinder, not shown, in which a slush ice beverage is prepared and stored for dispensing. Dispensing of the slush ice beverage is achieved by operation of dispensing valve 1, wherein an arm 3 of the valve, having an operating handle 3a, is manually rotated in the direction of an arrow A. The arm 3 operates against the tension of a spring (not shown) located in a spring housing 4 and moves in a movement limiting slot 5 to cause a valve mechanism (not shown) to open and result in a slush ice beverage flowing downward out of a lower end of a dispensing nozzle 6 and into a cup (not shown) positioned below the nozzle. When the cup is full, the arm 3 is released by the user and spring tension then moves the arm in the direction of an arrow B to an off position of the slush ice dispensing valve 1, resulting in dosing of the valve mechanism.

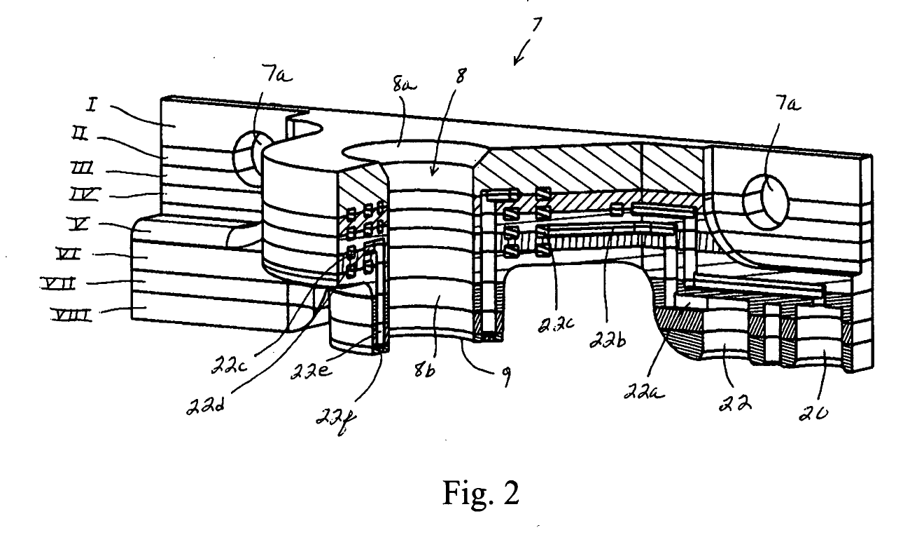

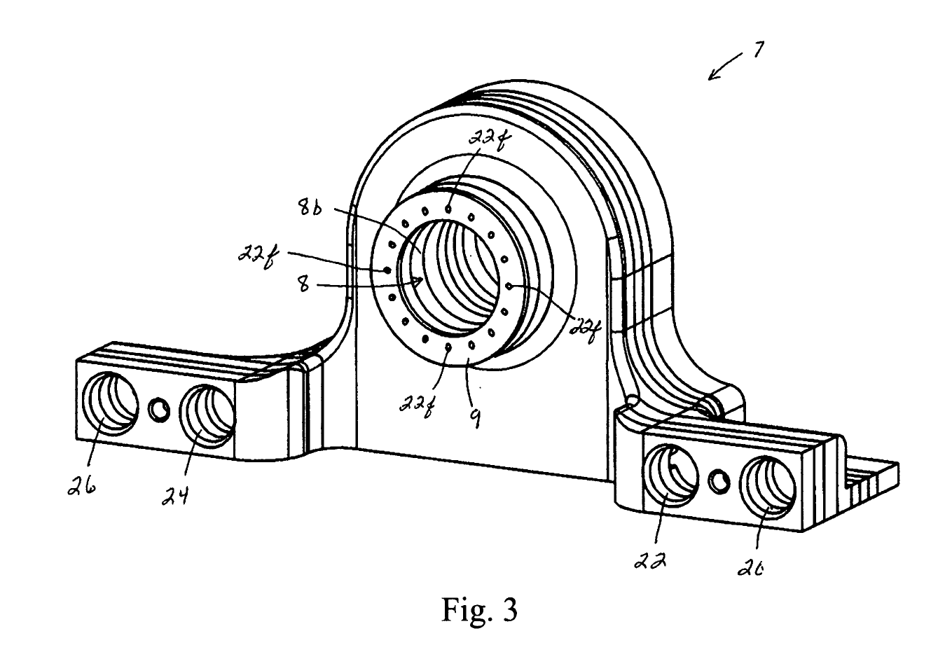

With reference also to FIGS. 2 and 3, there is shown a flavor injection assembly of the invention that is adapted to be secured to and work with a standard slush ice dispensing valve 1. The flavor injection assembly indudes an injection device, indicated generally at 7, comprising a body having holes 7a through which two of four bolts 7b extend to secure the injection device and the face plate 2 to the slush ice beverage dispensing machine, with the bottom two bolts securing the injection device and its mounting plate 7c to the face plate. The injection device 7 indudes a vertically extending central bore, indicated generally at 8, having an enlarged frustoconical shaped top portion 8a and a cylindrical shaped lower portion 8b. The injection device 7 has a generally flat and annular lower surface 9 surrounding and extending radially outward from a lower exit end of the cylindrical passage portion 8b of the central bore 8. The lower surface 9 lies in a generally horizontal plane and sixteen flavor injection outlets or orifices, as will be described, are in a circular array and in equally spaced angular relationship in and around the lower surface.

To facilitate its manufacture, the injection device 7 is comprised of eight generally planar plates or layers I-VIII that are sandwiched and fastened together to form the body of the injection device. The layers facilitate manufacture of the injection device 7 for the reason that its body, when assembled, is provided with a plurality of internal and relatively complex and circuitous passages or channels that extend between flavor additive inlets to the body and associated ones of the flavor outlet orifices in the lower surface 9, and by using layers to form the injection device, the formation of the passages within the body is greatly facilitated. For a better understanding of how and why layers may advantageously be used to provide inlets, outlets and passages in the body of an injection device, reference is made to said patent application Ser. No. 10/938,329, filed Sep. 10, 2004.

It is contemplated that adhesive be used to secure the layers I-VIII together, so that all of the various openings and channel or passage portions formed in the separate layers fit together and form fluidly separate flow channels through the injection device 7, although other suitable means may be used to secure the layers together in sandwiched relationship. It is important that the layers be sandwiched together in a manner that they accurately register one on top of the other, so that the channels and openings formed in adjacent layers are in proper registry. To ensure accurate registration when the layers are sandwiched together, registration holes may be provided in the layers, which extend through each layer for receiving a pair of registration pins of an assembly block when the layers are placed in the assembly block for being secured together. After the layers have been secured together, such as by gluing, any excess material and glue are removed to produce the injector or injection device 7.

When the layers are adhered together to form injection device 7, four fluidly separate flavor injection channels are formed and exist within the injection device. The four flavor injection channels have inlets at the entrances to respective bores 20, 22, 24 and 26, which receive respective inlet hose connectors 28 that provide for connection of the bores to pressurized sources of liquid additive flavors (not shown).

A view of a portion of the paths traveled through injection device 7 by the various flavors 14 can be had by reference to FIG. 2. For example, one of the four liquid additive flavors is delivered to the inlet to the bore 22, from which the additive flavor then flows through a flavor passageway 22a, 22b to a circular flavor passageway or ring 22c, and then around flavor ring 22c to a flavor ring 22d. From the flavor ring 22d, the additive flavor flows down four flavor down tubes 22e (only one of which is shown) to four flavor outlet orifices 22f, which comprise four of the sixteen flavor outlet orifices that open into the lower surface 9 of the injection device 7. A similar arrangement exists for each of the other three flavor additive inlet bores 20, 24 and 26, which bores connect through associated flavor additive passages and rings in the injection device 7 to associated sets of four each flavor additive outlet orifices 20f, 24f and 26f that also open into the lower surface 9. The four outlet orifices for each additive flavor 14 may be positioned in equiangular spaced relationship in the circular array of flavor additive outlet orifices 20f, 22f, 24f and 26f in the surface 9, as may be seen in respect of the flavor additive outlet orifices 22f, as shown in FIG. 3. The flavor additive outlet orifices 20f, 22f, 24f and 26f are directed or angled such that, with the slush ice dispensing valve 1 opened so that there is a flow of frozen slush beverage into an upper end of, through and out of a lower exit end of the central bore 8, flavor additives are emitted from the outlet orifices in a selected direction that may range from the flavor additives flowing generally parallel to the major flow of the slush ice beverage, for mixing with the slush ice beverage in a cup, to the flavor additives flowing at any reasonable angle toward and being impacted against the major flow of the slush ice beverage for mixing with the slush ice beverage before it enters the cup.

Referring to FIG. 1, in use of the injection device 7, a flavor selection mechanism, indicated generally at 30, is provided on the beverage dispenser. The flavor selection mechanism 30 includes a horizontal housing portion 32 that carries additive flavor selection switches 34a, 34b, 34c and 34d corresponding to each of the four additive flavors. A vertical housing portion 36 is secured to and over the spring housing 4 and includes a proximity sensor (not shown) retained within the housing 36, which senses when the valve arm 3 is in the open position for dispensing a slush ice beverage. A suitable control circuit (also not shown) is contained within housing portion 32 and is connected to the switches 34a-d and to the proximity sensor. When a slush ice drink is to have a flavor additive added to it, such for example as vanilla, lemon or cherry, the particular switch 34a-d corresponding to that flavor additive is first pressed, the arm 3 is then moved to open the beverage dispensing valve 1 and, when the arm 3 reaches the valve open position as sensed by the proximity sensor, the control circuit operates a solenoid to cause a remote flavor additive valve to open. The flavor additive valves provide for delivery in an on/off manner of additive flavors from pressurized sources of the additives. Once a remote flavor additive valve is opened, the selected flavor flows from the pressurized source thereof into, through and out of injection device 7 in a selected direction that may be parallel to or toward and into the stream of slush ice beverage after it flows through and exits from the central bore 8 of the injection device 7.

Because the outlet orifices 20f, 22f, 24f and 26f are provided in the lower generally horizontal and flat surface 9 of the injection device 7 outside of the central bore 8, carryover of additive flavor from one drink to the next is substantially reduced if not totally eliminated. In addition, for any cleanup as is necessary, the flat surface 9 is relatively small and easy to access. If desired, a targeting spout can be incorporated around the outlet orifices to align the cup with the flow when a dome is incorporated into the cup. In this connection, the outside diameter of the surface 9 advantageously is sized to accommodate extension of the surface through the central opening found in many domed cup lids, so that the surface 9 of the injection device 7 may be extended through the opening to fill the cup without need to remove the lid from the cup.

It is understood that while the injection device 7 of the present invention has been described for use with a slush ice beverage dispensing machine, that particular environment is intended to be merely illustrative of one of many potential applications for the invention. Further, while the dispense valve 1 of the beverage dispensing machine has been described as being manually operated, electrically or automatically operated dispense valves can just as readily be used with the injection device. The invention also is not limited to the addition of just four additive flavors to a fluid stream, but an injection device according the invention can be appropriately constructed and used to add any desired number of additive flavors. The invention can also be used to simultaneously add more than one additive flavor at a time or, if desired, be used in a manner to stagger the addition of multiple different additive flavors during dispensing of a base beverage.

While embodiments of the invention have been described in detail, various modification and other embodiments thereof may be devised by one skilled in the art without departing from the spirit and scope of the invention, as defined in the appended claims.

What is claimed is:

1. A nozzle for introducing additive fluids into a stream of a primary fluid, said nozzle comprising a body having a generally vertically extending bore for flow of a stream of primary fluid from an upper inlet to said bore to and through a lower outlet from said bore and a plurality of fluid flow channels, each said channel extending between an inlet to said channel for connection to an associated supply of additive fluid and a plurality of outlet orifices from said channel that open into a bottom surface of said body in angularly spaced relationship around and outside of said lower outlet from said bore for emission of flows of additive fluid from said orifices in directions to impinge the flows against the stream of primary fluid downstream from said lower outlet from bore and below a lowermost end of said nozzle.

2. A nozzle as in claim 1, wherein said plurality of outlet orifices from each fluid flow channel open into said bottom surface of said body in equally angularly spaced relationship around said lower outlet from said bore.

3. A nozzle as in claim 1, wherein said plurality of outlet orifices from each fluid flow channel open into said bottom surface of said body in a common plane.

4. A nozzle as in claim 1, wherein said body comprises a series of layers, each having a bore formed therethrough and a fluid flow channel formed in at least one surface thereof, said layers being registered one above the other and sandwiched together to form said body having said bore and said plurality of separate fluid flow channels extending through said body between said inlets to and said outlet orifices from said channels.

5. A nozzle as in claim 4, wherein facing surfaces of at least two adjacent layers have fluid flow channels formed therein which are complementary to each other and register one with the other to form a fluid flow channel through said body.

6. A nozzle as in claim 1, including means for controlling delivery of additive fluid to occur only in response to a flow of a primary fluid through said bore.

7. A beverage dispenser, comprising a valve for dispensing a stream of a beverage; and a nozzle for introducing additive fluid flavorings into the beverage, said nozzle including a body having a generally vertically extending bore for flow of a stream of beverage dispensed by said valve from an upper inlet to said bore to and through a lower outlet from said bore and a plurality of fluid flow channels, each said channel extending between an inlet to said channel for connection to an associated supply of additive fluid flavoring and a plurality of outlet orifices from said channel that open into a bottom surface of said body outside of and in angularly spaced relationship around said lower outlet from said bore for emission from said outlet orifices of flows of additive fluid flavoring in directions to impinge the flows against the stream of beverage downstream from said lower outlet from said bore and below a lowermost end of said nozzle.

8. A beverage dispenser as in claim 7, wherein an outlet from said valve is received in an upper portion of said bore.

9. A beverage dispenser as in claim 7, wherein said beverage dispenser is a slush ice dispenser and said valve dispenses a stream of slush ice.

10. A beverage dispenser as in claim 7, wherein said plurality of outlet orifices from each fluid flow channel open into said bottom surface of said body in a common plane.

11. A beverage dispenser as in claim 7, wherein said plurality of outlet orifices from each said fluid flow channel open into said bottom surface of said body in equally angularly spaced relationship around said lower outlet from said bore.

12. A beverage dispenser as in claim 7, wherein said body comprises a series of layers, each said layer having a bore formed therethrough and a fluid flow channel formed in at least one surface thereof, said layers being registered one above the other and sandwiched together to form said body having said bore and said plurality of separate fluid flow channels extending through said body between said inlets to and said outlet orifices from said channels.

13. A beverage dispenser as in claim 13, wherein facing surfaces of at least two adjacent layers have fluid flow channels formed therein which are complementary to each other and register one with the other to form a fluid flow channel through said body.

14. A method of introducing additive liquid flavorings into a stream of a beverage dispensed from a beverage dispensing valve of a beverage dispenser, said method comprising the steps of:
providing a body having a generally vertically extending bore for flow of a stream of beverage from an upper inlet to the bore to and through a lower outlet from the bore and a plurality of fluid flow channels, each channel extending through the body between an inlet to the channel and a plurality of outlet orifices from the channel that open into a bottom surface of the body outside of and around the lower outlet from bore;
fluid coupling the inlet to each channel to an associated supply of additive liquid flavoring;
operating the beverage dispensing valve to flow a stream of beverage into the upper inlet to and through and out of the lower outlet from the bore;
delivering additive liquid flavoring to the inlet to a channel for flow through the channel to and out of the outlet orifices from the channel; and
directing the additive liquid flavoring from each of the channel outlet orifices in a direction to impinge the additive liquid flavoring against the stream of beverage downstream from the lower outlet from the bore and below a lowermost end of the nozzle.

15. A method as in claim 14, wherein the plurality of outlet orifices of each channel open into the bottom surface of the body in a common plane and in angularly spaced relationship around the lower outlet from the bore.

16. A method as in claim 14, wherein the plurality of outlet orifices of each channel open into the bottom surface of the body in equally angularly spaced relationship around the lower outlet from the bore.

17. A method as in claim 14, wherein said step of providing a body comprises the steps of providing a series of layers, each having a bore and a fluid flow channel in at least one surface thereof, registering the layers one above the other, sandwiching the layers together to form the body having the bore and the plurality of separate fluid flow channels extending through the body between the inlets to and the outlet orifices from the channels, and fastening the layers together.

18. A method as in claim 14, wherein facing surfaces of at least two adjacent layers have fluid flow channels which are complementary to each other and register one with the other to form a fluid flow channel through the body.
